(19) United States
(12) Patent Application Publication
(10) Pub. No.: US 2022/0410317 A1
(43) Pub. Date: Dec. 29, 2022

(54) ARRANGEMENT OF A LASER RADIATION FOR CATALYSIS IN COMPLEXATION REACTIONS

(71) Applicant: PETRÓLEO BRASILEIRO S.A. - PETROBRAS, Rio de Janeiro (BR)

(72) Inventors: Mario GERMINO FERREIRA DA SILVA, Rio de Janeiro (BR); Rosane ALVES FONTES, Petropolis (BR); Francisca FERREIRA DO ROSARIO, Rio de Janeiro (BR); Katia Regina SIL VA ALVES DA ROSA, Rio de Janeiro (BR); Felipe BATISTA ALVIM, Rio de Janeiro (BR)

(73) Assignee: PETRÓLEO BRASILEIRO S.A. - PETROBRAS, Rio de Janeiro (BR)

(21) Appl. No.: 17/781,254

(22) PCT Filed: Nov. 19, 2020
(86) PCT No.: PCT/BR2020/050490

§ 371 Date: May 31, 2022

(30) Foreign Application Priority Data
Nov. 29, 2019 (BR) BR10 2019 0254181

(51) Int. Cl. B23K 26/36; B08B 9/02

(52) U.S. Cl. CPC B23K 26/36; B08B 9/02

(57) ABSTRACT

The present invention addresses to an adaptation of a laser system in a reactor for the application of laser radiation, promoting the thermal catalysis of the complexation reactions of barium sulfate (BaSO₄), strontium sulfate (SrSO₄) and CaCO₃ with application in fields of drilling and completion of wells, as well as lifting and draining systems; in this case, aiming at the removal of scale at an appropriate temperature for the complexation and consequent dissolution of the scale salt in subsea equipment of the production systems.

### FIELD OF THE INVENTION

The present invention addresses to an adaptation of a laser system in a reactor for the application of laser radiation. Laser radiation is, in this case, applied to promote the thermal catalysis of the complexation reactions of barium sulfate (BaSO₄) and/or strontium sulfate (SrSO₄) salts with chelating agents, aiming at the dissolution of these salts. The main objective of this invention is the application of the technology in the fields of drilling and completion of oil wells, as well as in the area of lifting and draining oil, in equipment of marine production systems.

### DESCRIPTION OF THE STATE OF THE ART

The temperature of the seabed in water depths from 700 meters deep is around 4° C. Therefore, in marine production systems that are in water depths greater than 700 meters, the oil temperature when arriving at the surface is between 9 and 15° C. In fields located in this range of water depth, the formation of saline scale can occur, for example, in risers, production lines, manifolds, wet Christmas tree (WTC), and production strings. Chemical treatment to remove these scales, in this case, implies that the complexation reaction is limited to a temperature around 20° C.

Subsea equipment used for the flow of oil production, such as wet Christmas tree, production lines, and manifolds, are immersed in the seabed. The heat exchange of these pieces of equipment with the produced fluid leads to its cooling along the distance from the well to the SPU. The reduction in the temperature of the produced fluids can cause the precipitation of compounds such as paraffins, asphaltenes and saline scales inside these pieces of equipment. In extreme cases, a total obstruction of the place where these compounds are deposited may occur, leading to production losses resulting from the need for intervention in the producing well. Specifically, in the case of saline scale, one of the unclogging treatments involves the use of chelating agents (e.g., EDTA, DTPA).

In general, the chelating agent forms a soluble complex with the cations present in the inorganic scales, thus promoting its dissolution and, consequently, its removal. The treatment of saline scale removal is normally carried out by pumping chelating solutions that are positioned inside the scaled subsea equipment. The kinetics of the complexation reaction depends, among other variables, on temperatures between 60° C. and 80° C., preferably 80° C., for application of DTPA as a chelating agent. The temperature reduction caused by the heat exchange of the fluids produced with the subsea equipment thus affects the efficiency of the reaction.

The solution achieved by the invention is the pumping of the scale removal solution at an appropriate temperature for the complexation reaction in equipment of subsea production systems.

In the operation of removing saline scales with the use of chelating agents, the solution is, in general, pumped through the gas lift line to the section of the production line, or other equipment where there is a deposit, followed by soaking. The limitation of this operation consists of the cooling of the chelating solution due to the heat exchange with the lift gas line.

In this way, the need to carry out the heating of the solution was identified, wherein it is proposed in the present invention, by means of the use of laser radiation, to promote the thermal catalysis of the complexation reactions of barium sulfate (BaSO₄) and/or strontium sulfate (SrSO₄).

Document U.S. Pat. No. 5,282,995 discloses method and chemical solution for removing scale deposits of barium and strontium sulfate. The solution is composed of a chelating agent of EDTA (ethylenediamine tetraacetic acid) or DTPA (diethylenetriamine pentaacetic acid) in aqueous medium, with pH between 8 and 14, and a catalyst or synergist. EDTA and DTPA are the most commonly used chelating agents, or the alkaline salts thereof. The adopted catalysts are made up of anions of organic and inorganic acids, such as fluorine, oxalate, persulfate, dithionate, hypochlorite and formate. When the chelating solution is brought into contact with a surface containing a scale deposit, the deposit dissolves substantially faster.

Document BR120120267438 discloses a device for removing gas hydrates present on the surface of equipment used in subsea production and exploration. The device consists of a main vessel and a power cable connected one another and, inside the vessel, a laser apparatus connected to an adjustable focus collimator. The wavelength emitted by the laser is between 200 nm and 930 nm. When radiation strikes the subsea exploration equipment, it causes heating, which, in turn, heats the hydrate by conduction, leading to its dissociation. On the front cover of the vessel, there is a window for the interface between the vessel and the aqueous medium, and this window is provided with an anti-reflection film. The method of removing gas hydrates from surfaces of equipment used in subsea production and exploration with the aid of the tool is also described.

Document BR1120170139065 discloses an anti-biofouling lighting system, configured to prevent or reduce the formation of biofouling on a susceptible element. The element susceptible to fouling is, during use, at least partially mobile and is exposed, at least partially, to water. The formation of biofouling is prevented by irradiating an antifouling light on the element in question. The anti-fouling lighting system comprises at least one laser light source configured to generate anti-fouling light and to apply this light to said element. The system is arranged so that, during its application, the element susceptible to fouling moves, at least partially, in relation to the laser light source.

In the search for solutions to the challenges, there is, for example, the limitation to carry out the treatment in horizontal wells, due to the difficulty of pumping the chemical product with a defined positioning and temperature above 20° C. The present invention proposes the application of laser radiation for the catalysis of complexation reactions related to the dissolution of saline scale, aiming at increasing the efficiency of scale removal treatments in marine production systems.

No document of the state of the art discloses the use of laser and the application in a controlled manner for heating the complexation solution, in order to promote the thermal catalysis of the reaction with barium sulfate (BaSO₄) and/or strontium sulfate (SrSO₄) salts as in the present invention.

### BRIEF DESCRIPTION OF THE INVENTION

The present invention addresses to the development of a laser catalysis technology, by means of the adaptation of a laser system in a reactor, for the application of laser radiation in complexation reactions of a chelating agent with a scaling salt, aiming at increasing the temperature in the reaction medium.

The proposal is to use laser radiation in a controlled manner in order to generate the necessary heating for the reaction of the chelating agents with saline scales of BaSO₄ (barium sulfate) and/or SrSO₄ (strontium sulfate), or even CaCO₃ (calcium carbonate), occurs at a suitable temperature for a better yield, making the process of removing scale from equipment in the subsea production system more efficient.

### BRIEF DESCRIPTION OF DRAWINGS

The present invention will be described in more detail below, with reference to the attached figures which, in a schematic form and not limiting the inventive scope, represent examples of its embodiment. In the drawings, there are:

FIG. 1 illustrating a subsea production scheme consisting of a well production scheme, WTC, and subsea line to the SPU (Stationary Production Unit);

FIG. 2 illustrating the thermal profile of the water in the Campos basin;

FIG. 3 illustrating a metal-EDTA complex;

FIG. 4 illustrating a carbonate thermal decomposition profile;

FIG. 5 illustrating a Baryte Dissolution Test in DTPA, EDTA, CDTA, and 0.18 M DOTA at 40° C. in a stirred system;

FIG. 6 illustrating chemical structures of chelating agents;

FIG. 7 illustrating an experimental arrangement consisting of a reactor provided with stirring and irradiation on the reactor wall;

FIG. 8 illustrating an experimental arrangement consisting of a reactor provided with stirring with external irradiation on the solution inside the reactor;

FIG. 9 illustrating an experimental arrangement consisting of a reactor provided with stirring with internal irradiation on the solution inside the reactor;

FIG. 10 illustrating a scheme of adaptation of the laser pen to the reactor of the present invention;

FIG. 11 illustrating a view of the adapter on the cover of the reactor of the present invention;

FIG. 12 illustrating a clamp type laser pen adapter coupled to the reactor;

FIG. 13 illustrating a clamp type laser pen adapter coupled to the reactor cover;

FIG. 14 illustrating a laser pen adapter coupled to the reactor with thread and nut;

FIG. 15 illustrating a laser pen adapter attached to the reactor cover with thread and nut.

### DETAILED DESCRIPTION OF THE INVENTION

The present invention addresses to the development of a catalysis technology, by means of the adaptation of a laser system in a reactor for application of laser radiation in the complexation reaction of a chelating agent with an inorganic salt, aiming at increasing the temperature of the reaction.

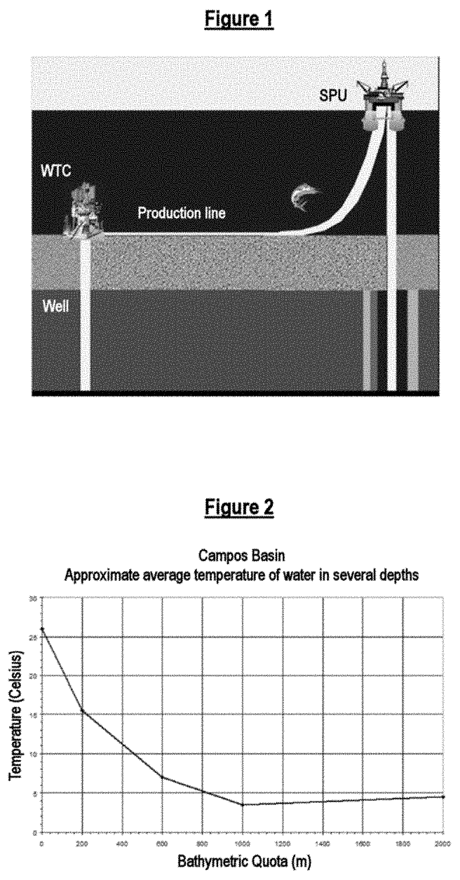

In FIG. 1, there is a subsea production scheme consisting of a well production scheme, WTC, and a subsea line to the SPU. The seabed temperatures decrease until water depths around 700 meters. From this depth on, the temperature remains at approximately 4° C. FIG. 2 presents a thermal profile of the water in the Campos basin.

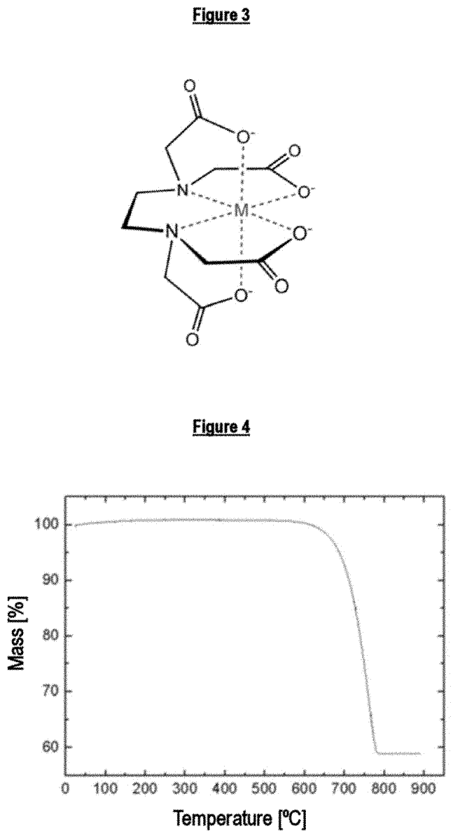

A complexing agent applied in the dissolution of saline scales is EDTA (the acronym in English), ethylenediamine tetraacetic acid. EDTA is an organic compound that acts as a chelating agent, forming soluble complexes with various metal ions. EDTA acts as a hexadentate ligand; that is, it can complex with the metal ion by six coordination positions, namely: by four carboxylate anions (—COO—), after the 4H+ leave the carboxylic groups, and also by the two N, as shown in FIG. 3.

Another commonly used chelating agent is DTPA (the acronym in English), diethylene triamine pentaacetic acid. DTPA is a polycarboxylic amino acid consisting of a diethylene triamine backbone with five carboxymethyl groups. The molecule can be seen as an expanded version of EDTA and is used in a similar way. It is a white solid, soluble in water.

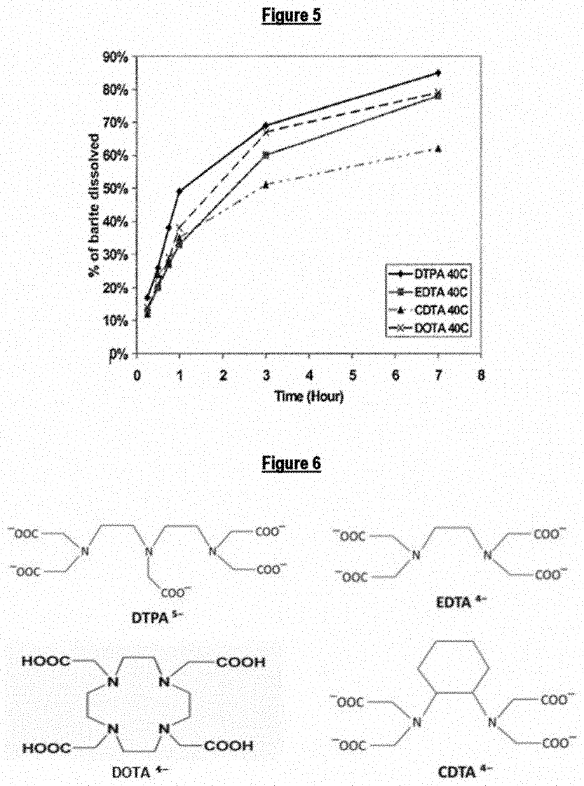

The DTPA conjugate base has a high affinity for metal cations. Thus, DTPA⁵⁻ penta-anion is potentially an octadentate ligand, considering that each nitrogen center and each COO— group count as a center for coordination. The formation constants of their complexes are about 100 times greater than those for EDTA (“Roger Hart, 2005”). As a chelating agent, DTPA involves the metal ion and can form up to eight bonds. However, with transition metals, they form fewer than eight coordination bonds. Thus, after forming a complex with a metal, DTPA still has the ability to bind other reagents. The literature presents DTPA (“Wang, et al., 2002”) as the most efficient complexing agent for the dissolution of barium sulfate (FIG. 5), (“Lakatos; Szabó, 2005; Jordan, et al, 2012”). Studies carried out with the application of laser radiation on rocks are already known in the literature. In fact, the application of laser on carbonate rocks was developed with the objective of verifying possible performance gains in drilling operations and in increasing efficiency in perforating operations (“Valente et al., 2012”). The creation of a tunnel in carbonate rock is possible due to the thermal decomposition reaction of the carbonate, which occurs in the range of 600° C. to 780° C. In FIG. 4, the graph shows the mass reduction profile as a function of the exposure temperature of the carbonate sample. In the region of the sample where laser radiation was applied, calcium carbonate (CaCO₃) decomposes into calcium oxide (CaO) and carbon dioxide (CO₂).

The present invention reports the possibility of applying laser radiation in a controlled way, promoting the necessary heating for the reactions of the chelating agents with saline scales of BaSO₄ (barium sulfate) and/or SrSO₄ (strontium sulfate), or even CaCO₃ (calcium carbonate), occur at the appropriate temperature for a higher yield, thus making the scale removal process more efficient.

The application of the laser to carry out scale removal operations in subsea production equipment has the following advantages:
Improved efficiency of scale removal with chemical treatment;
Control of heat exchange in deep water depths during the scale removal treatment;
Collaboration with the recovery and maintenance of production in oil well production systems.

A Baryte Dissolution Test in different chelators, such as DTPA, EDTA, CDTA, and DOTA, at a concentration of 0.18 M and a temperature of 40° C., with a system with constant stirring for a time of 7 hours, can be seen in FIG. 5.

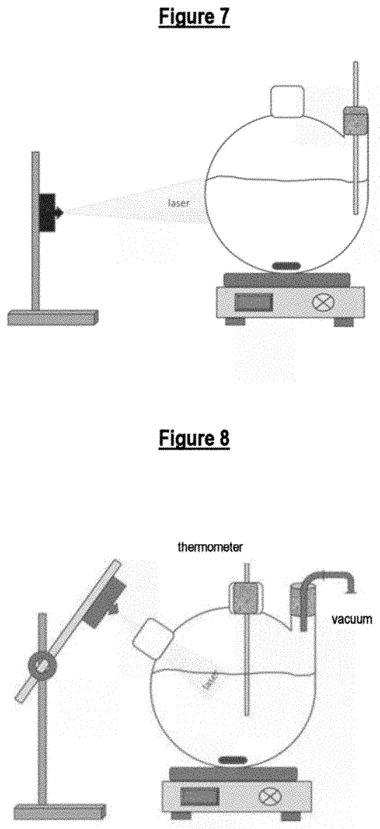

The chemical structures of the chelating agents DTPA, EDTA, CDTA, and DOTA can be seen in FIG. 6.

Table 1 shows the dissolution parameters of sulfate in the different chelators:

TABLE 1
Barium sulfate dissolution parameters

| | K_{(40° C.)} | K_{(60° C.)} | K_{(80° C.)} | Eₐ | A | Log |
|---|---|---|---|---|---|---|
| Agent | (h⁻¹) | (h⁻¹) | (h⁻¹) | (kcal/mol) | (h⁻¹) | (A) |
| DTPA | 0.73 | 1.94 | 4.79 | 10.32 | 1.17 × 10⁷ | 7 |
| DOTA | 0.63 | 1.78 | 3.41 | 8.87 | 1.10 × 10⁶ | 6 |
| EDTA | 0.43 | 0.74 | 1.43 | 6.57 | 1.63 × 10⁴ | 4 |
| CDTA | 0.11 | 0.17 | 0.23 | 4.27 | 7.61 × 10² | 2 |

Notes:
kc is determined by the Arrhenius equation:
kc = A exp (−Eₐ/RT)
kc = reaction constant (h⁻¹)
A = frequency factor (h⁻¹)
Eₐ = activation energy (kcal/mol)
R = ideal gas constant (1.987 cal/mol · K)
T = temperature, Kelvin

The appropriate temperature for the kinetics of the complexation reaction is between 60° C. and 80° C. for the application of DTPA as a chelating agent in the removal of saline scale in subsea production systems.

Laboratory tests for laser application for heating the barium sulfate reaction with complexing agents such as DPTA, DOTA, EDTA, CDTA, and mixtures of these chelators, among others, can be performed using one of the apparatuses described in the FIGS. 7, 8 and 9.

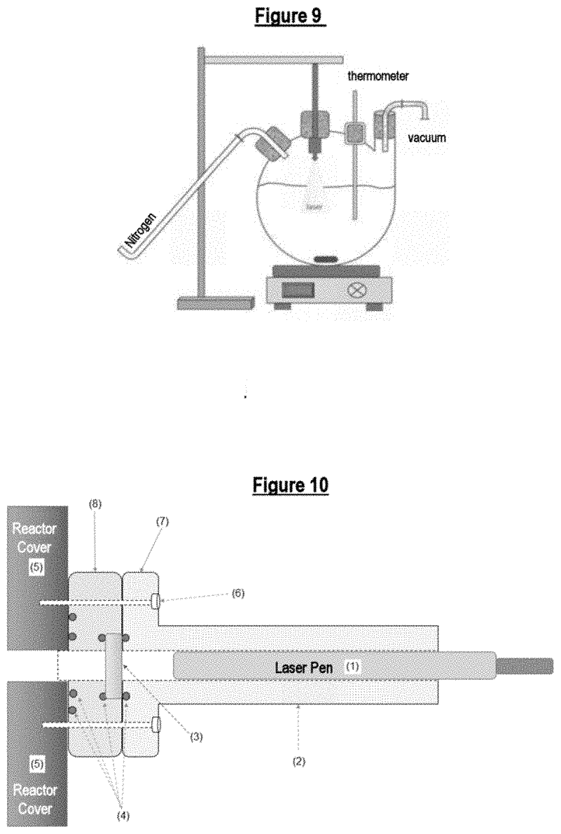

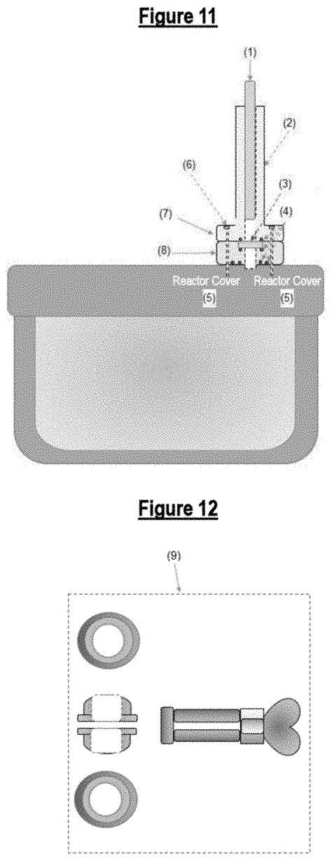

Heating can be performed in at least three ways: the first way is by the direct application of laser radiation on the outside of the wall of the flask or reactor that contains the mixture of the BaSO₄ sample with the chelator, as shown in FIG. 7. A second way is by the application of laser radiation on the outside of the flask or reactor inside the reactor, focusing directly on the reaction mixture, as seen in FIG. 8. The third way is by the adaptation of the laser for direct application inside the reactor (FIG. 9). In all cases, constant stirring is maintained to homogenize the heat distribution in the mixture. The experiments should start with the reaction system at a temperature around 20° C., which is heated until it reaches 80° C.

### EXAMPLE 1

### Experiment with Direct Application of Laser Radiation on the Outside of the Flask Wall (FIG. 7).

This arrangement proposal has the advantage of not exposing the collimator lens to the vapors generated by heating the sample. On the other hand, it has disadvantages, since the analysis of the interaction of photons with the solute (degradation evaluation) will be impaired by the attenuation exerted by the flask wall, as well as there is a risk of cracking the flask, although this risk can be minimized by adjusting of the laser focus. Another disadvantage that the attenuation of the flask wall offers is the reduction of the efficiency of the heat production by the laser on the reaction medium.

### EXAMPLE 2

### Experiment with Direct Application of Laser Radiation to the Sample Without Coupling to the Reactor (FIG. 8).

This arrangement proposal has the advantage of allowing the evaluation of the interaction of photons with the solute, since there are no barriers that promote attenuation. The disadvantage is the risk of fouling the collimator lens. To minimize this risk, it is possible to use the reactor inside a hood with exhaustion and, coupled to the reactor, a system that ventilates air in the position of application of the laser collimator, in addition to a vacuum system in the position opposite to the collimator, thus allowing the removal of vapors generated during heating.

### EXAMPLE 3

### Experiment with Direct Application of Laser Radiation to the Sample With Coupling to the Reactor (FIG. 9).

This arrangement proposal also has the advantage of allowing the evaluation of the interaction of photons with the solute and as a disadvantage the risk of fouling the collimator lens. To minimize this risk, it is possible to use a system coupled to the reactor that vents nitrogen or air in a position opposite to the application of vacuum, in a way that promotes the removal of vapors generated by heating the sample.

### Laser Power to be Applied in the Laboratory

The power of a laser is measured in Watts. To calculate the thermal power, apply the equation below:

$$P = \frac{mc Δ {T}^{′}}{{E}_{f} Δ t}$$

### Where:

P-Power (w)
m-mass of water (kg)
c-specific heat of the material
ΔT-temperature variation (k)
E_{f}-Efficiency
Δt-time interval

The specific heat of water is the amount of heat to raise the temperature of 1 gram of water by 1° C., and its value is 1 cal/g° C.

To calculate the power, it is estimated that the wall of the flask will reflect 25% of the photons emitted by the laser; that is, the efficiency is estimated at 75%. This value depends on the purity of the materials used and may change.

$$P = \frac{mc Δ {T}^{′}}{{E}_{f} Δ t} = \frac{1 kg \times 1 kcal / ( kg \times K ) \times ( 50 K )}{0.75 \times 600 seg} \times \frac{4.186 \text{.8} J}{1 kcal} = 465.2 \frac{J}{seg} ou 465.2 W$$

kg-kilogram
kcal-kilocalorie
K-Kelvin
J-Joule
W-Watt

The laser power required for application in the complexation reactions of BaSO₄ with chelating agents is dimensioned by calculation. A reaction volume of 1000 ml and a heating time of 10 minutes are considered. Thus, for the acquisition of the laser for heating the reaction on the bench, a power of 500 Watts and a wavelength of high absorbance for water between 900 and 1060 nm are used, since the absorbed light is transformed into energy, and the higher the energy, the higher the temperature.

The Absorption Spectroscopy correlates the amount of energy absorbed as a function of the wavelength of incident radiation.

Water is used to calibrate the parameters of the laser application to heat the reaction medium. However, when applying radiation with the same wavelength over the mixture for the complexation and consequent dissolution of barium sulfate, greater efficiency is expected as a function of the absorbance of the dissolved material.

### Types of Adaptation of the Laser to the Reactor

The possibilities of adaptations to couple the laser to the reactor were evaluated. The laser system selected corresponded to the one that allowed the best possible coupling to the reactor. For reasons of component sizing, in this case, the collimator in a laser pen had the smallest diameter.

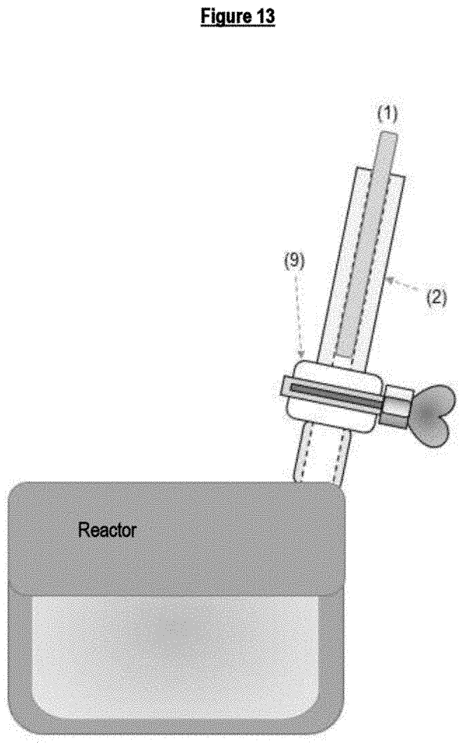

The laser pen coupling scheme to the reactor cover, as shown in FIG. 11, can have two types of adapters: the clamp type and the threaded and nut type, shown in FIGS. 13 to 16.

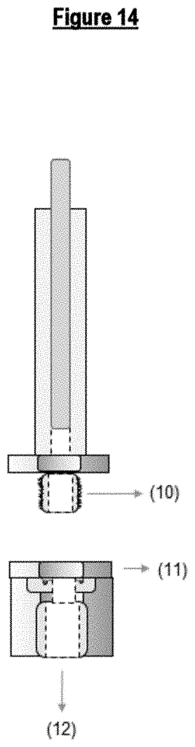

The clamp type adapter aims to fasten the pen support (holder) on the reactor cover, as shown in FIGS. 13 and 14. The stainless-steel clamp will unite and fasten the upper and lower parts (welded to the cover of the reactor) with the holder. In this way, we seek to save space in the area over the reactor cover.

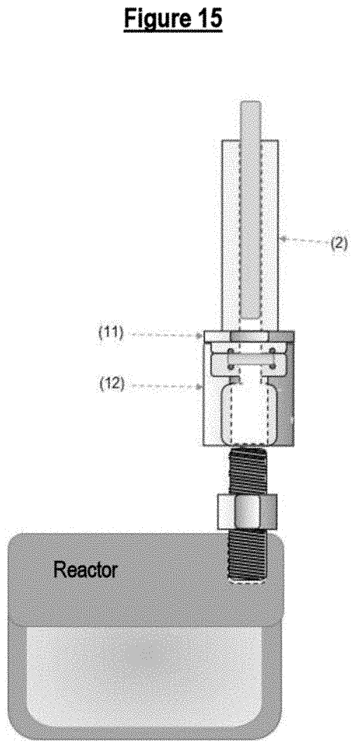

The adapter with thread and nut aims at fastening the pen support (holder) on the reactor cover, as indicated in FIGS. 15 and 16, using a Swagelok connection (nut and thread). This connection will unite and fasten the upper and lower parts with the holder, in addition to being machined with a thread and nut on the reactor cover. The adapter will be screwed onto the reactor cover via a Swagelok-type connection. In this way, we seek to save space in the area over the reactor cover.

It should be noted that, although the present invention has been described in relation to the attached figures, it may undergo modifications and adaptations by technicians skilled on the subject, depending on the specific situation, but provided that it is within the inventive scope defined herein.

1. AN ARRANGEMENT OF A LASER RADIATION FOR CATALYSIS IN COMPLEXATION REACTIONS, characterized in that it comprises a laser pen (1) inserted within a pen holder (2), wherein said holder has a flange (7) that is fastened to the flange (8) of the reactor cover (5) by means of fastening screws (6) which perforate the reactor cover (5); additionally between the flanges (7) and (8), it has a silica window (3) where O-ring type sealing rings (4) are used both between the flanges (7) and (8) and on the reactor cover (5).

2. THE ARRANGEMENT OF A LASER RADIATION FOR CATALYSIS IN COMPLEXATION REACTIONS according to claim 1, characterized in that the fastening screws (6) are of the clamp type (9) or thread (10) and nut (11) type.

3. THE ARRANGEMENT OF A LASER RADIATION FOR CATALYSIS IN COMPLEXATION REACTIONS according to claim 2, characterized in that the fastenings screws (6) of thread (10) and nut (11) type comprise a fastened part (12) to fit into the adapter of the reactor cover (5).
